(19) United States
(12) Patent Application Publication
(10) Pub. No.: US 2005/0086563 A1
(43) Pub. Date: Apr. 21, 2005

(54) Channel-based testing of communication link

(75) Inventor: Juan-Antonio Carballo, Austin, TX (US)

Correspondence Address: IBM CORPORATION (DWL);C/O LALLY & LALLY, L.L.P., P. O. BOX 684749, AUSTIN, TX, 78768-4749, US

(73) Assignee: International Business Machines Corporation, Armonk, NY (US)

(21) Appl. No.: 10/687,257

(22) Filed: Oct. 16, 2003

(51) Int. Cl. G06F 11/00

(52) U.S. Cl. 714/704

(57) ABSTRACT

A communication link receiver for use in a data processing system includes a receive interface, a clock/data recovery (CDR) circuit, and a debug unit. The receive interface receives a test signal from the communication channel. The CDR circuit is configured to extract a clock signal and a test data signal from the received signal. A debug unit determines a bit error rate (BER) of the test data signal and at least one jitter characteristic of the communication link. The debug unit further includes a test advisor to recommend corrective action, based on the BER and the jitter characteristic(s) when the BER exceeds a predetermined threshold. The corrective action recommended can include transmitting an additional test pattern when the BER is high, but the jitter characteristics are acceptable or modifying a CDR characteristic, such as the sampling rate or bandwidth, when the BER and at least one jitter characteristic exceed their predetermined thresholds.

### BACKGROUND

1. Field of the Present Invention

The present invention is in the field of electronic systems and more particularly in the field of high speed communication links in an electronic system.

2. History of Related Art

An integrated communication link refers to the hardware system interface between two components and is composed of integrated transmitter and receiver circuits directly connected to a communication channel. Each of the components can be a general purpose processor, a memory, an application specific integrated circuit (ASIC), or another electronic device. A communication channel refers to the physical medium connecting a pair of components. Integrated communication links are found on an increasing number of integrated circuits. System-on-a-chip devices, for example, now frequently incorporate an on-board communication link enabling the device to communicate with system memory and other devices. Because of a growing number of high speed communication standards and applications, however, it is generally difficult to predict the exact application and environment in which such components will be used. Designing to a generalized specification, such as a “bathtub curve” type of specification indicating a projected bit error rate (BER) as a function of the sampling point, is generally insufficient to guarantee an acceptable BER in any particular implementation. Therefore, it is generally necessary to test, characterize, and optimize a link as it is implemented in a given application to identify the existence and cause of any malfunctions. In addition to being able to identify malfunctions, the implemented test solution must be easy to use and efficient in terms of elapsed test time. These requirements generally dictate the use of an “at-speed” test solution.

Communication links, unfortunately, are generally not amenable to at-speed test and diagnosis. Pattern-based at-speed testing using pseudo-random-bit-streams (PRBS) or similar approaches does not provide much debugging or diagnosis capability. Direct debugging by, for example, capturing internal signals at speed is not a realistic option. Although there has been work in detecting low-level indicators, such as jitter, this work generally requires substantial extra circuitry, and does not directly point to a system-level malfunction. Therefore, it would be highly desirable to implement a system and method to test and diagnose a communication link at speed. It would be further desirable if the implemented system and method included the ability to detect whether a selected link configuration is appropriate for the communication channel to which it is connected and to determine, if the link configuration is not adequate, what parts of the link design are responsible for the problem.

### SUMMARY OF THE INVENTION

The goal identified above is achieved by a communication link for use in a data processing system according to the present invention. The communication link's receiver includes a receive interface, a clock/data recovery (CDR) circuit, and a debug unit. The receive interface receives a test signal transmitted over a communication channel and converts the voltage levels of the test signal. The CDR circuit is coupled to the receive interface and is configured to extract a clock signal and a test data signal from the received signal. A debug unit determines a bit error rate (BER) of the test data signal and at least one jitter characteristic of the signal by determining statistics associated with the CDR loop signals. The debug unit further includes a test advisor to recommend corrective action, based on the BER and the jitter characteristic(s) when the BER exceeds a predetermined threshold. The communication link further includes a transmitter having a transmit interface connected to the communication channel and a pattern generator that is connectable to the transmitter. The receive interface is preferably configured to convert non-return to zero (NRZ) formatted serial data to parallel format data with CMOS signal levels. The corrective action recommended by the debug unit can include performing at least one additional test using an additional test pattern when the BER exceeds the predetermined threshold but the jitter characteristics are acceptable. The recommended corrective action could also include modifying a characteristic of the CDR, such as the sampling rate or bandwidth, when the BER exceeds the predetermined threshold and at least one of the jitter characteristics exceeds a specified threshold. The CDR circuit includes an edge detection unit and a phase rotator control unit. An output of the edge detection unit indicative of the CDR's high frequency jitter and an output from the phase rotator control unit indicative of the CDR's frequency offset may be provided to the debug unit. In one embodiment, the debug unit employs and accesses a look up table (LUT) containing a plurality of entries, each entry having an associated BER value and at least one jitter characteristic value, to facilitate the problem determination and corrective action recommendation.

### BRIEF DESCRIPTION OF THE DRAWINGS

Other objects and advantages of the invention will become apparent upon reading the following detailed description and upon reference to the accompanying drawings in which:

FIG. 1 is a block diagram of an embodiment of a data processing system according to the present invention including a communication link and an inter-device communication channel;

FIG. 2 is a block diagram of selected elements of a communication link of FIG. 1 according to one embodiment of the present invention;

FIG. 3 is a block diagram showing additional detail of components of the communication link of FIG. 2; and

FIG. 4 is a conceptual representation of a lookup table implementation of a test advisor engine of the communication link of FIG. 3.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking the invention contemplates a communication link of a data processing system. The link is enabled to perform on-chip, at-speed testing and analysis or diagnosis of system communication configuration, which includes the link itself as well as the communication channel in which the link is embedded. A data pattern is generated by a transmitting device to create simulated data. The simulated data and the transmitter's clock signal are serialized and transmitted over the communication channel to the link. The link's receive interface modifies the voltage levels of the received data for use with CMOS logic and provides the data to a clock/data recovery (CDR) circuitry. The CDR includes edge detection and phase correction or rotation circuitry that function to extract the clock signal from the received signal. Internal signals from the CDR are provided to a debug circuit of the receiver. A CDR loop statistics calculator in the debug circuit determines jitter statistics and frequency offset statistics indicative of the link's system jitter characteristics.

Simultaneously, the actual pattern data extracted by the CDR is selected and provided to an error checker of the debug unit. The error checker compares the actual data against expected data based on the generated data pattern to determine a bit error rate (BER). The debug unit includes an engine that receives the link statistics and the BER information. Based on the combination of the two, the engine generates a diagnostic recommendation when the BER is unacceptably high. By considering the link's statistics in conjunction with the bit error rate, the debug unit engine is able to identify the most probable candidates for improving the application. If, for example, the BER is unacceptably high, but the jitter statistics extracted from the CDR are acceptable, then the engine may indicate a channel-based problem such as group delay, and may recommend further testing with a jitter tolerance pattern to confirm this hypothesis. If, the BER is too high and high (or low) frequency jitter statistics are higher than expected, the engine may indicate that the link design is insufficient for the given channel. Thus, a corresponding problem associated with the link implementation or configuration may be identified as a potential source of the problem, and an appropriate diagnostic procedure may be suggested to verify. As a result, the engine indicates that an aspect of the CDR loop needs to be modified or that the circuit should be used with an “easier” channel or application.

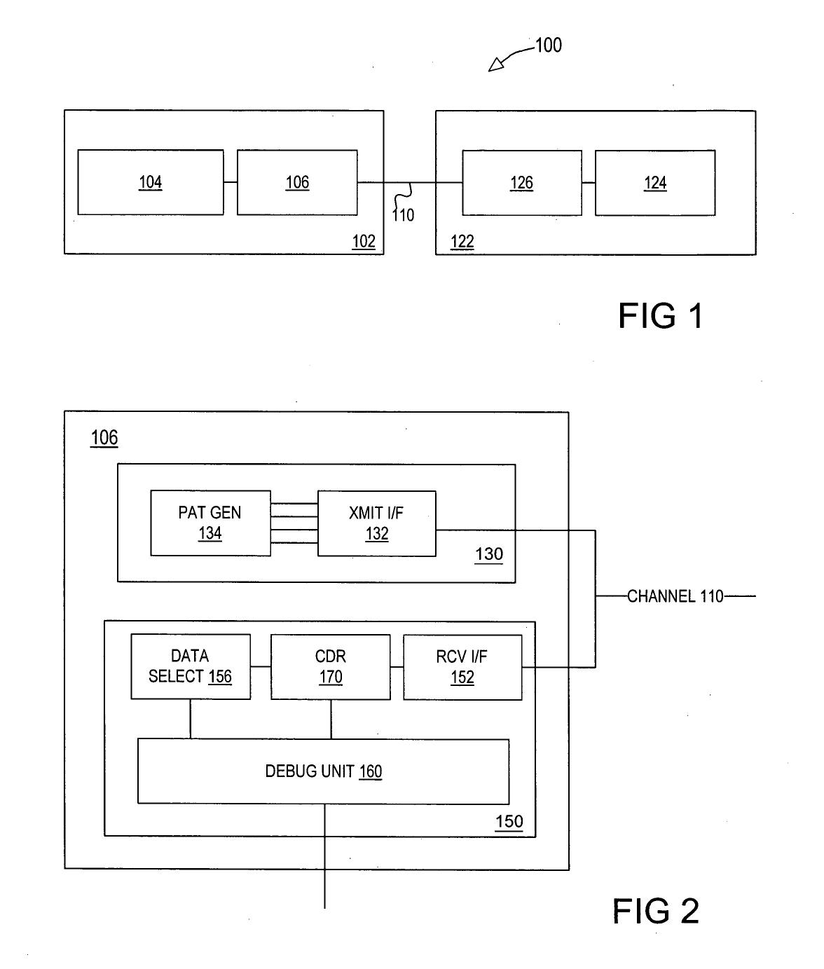

Turning now to the drawings, FIG. 1 depicts selected elements of a data processing system 100 according to one embodiment of the present invention. In the depicted embodiment system 100 includes a first device 102, a second device 122, and a communication channel 110 connecting the devices together. First and second devices 102 and 122 may be implemented as substantially any digital electronic device. First device 102, for example, may be a general purpose microprocessor while second device 122 represents a system memory. Alternatively, devices 102 and 122 may both represent application specific integrated circuits (ASIC's). In the most likely embodiments contemplated, first and second devices 102 and 122 are distinct devices in the sense that they are formed on separate substrates and packaged in different packages. In most embodiments, first and second devices 102 and 122 operate off of different clock generators. Communication link 110 is typically a serial link that may be implemented as a backplane interconnect, a printed circuit board wire, an optical fiber, or any of various other physical media suitable for high speed (in excess of 1 Mb/sec, and most often in the Gb/sec range) data communication.

For the purpose of emphasizing inter-device communication, first device 102 is shown as comprised of functional circuitry 104 and a communication link 106 while second device 122 is shown as including functional circuitry 124 and a communication link 126. The present invention embodies virtually any implementation of functional circuits 104 and 124 whether they represent a general purpose processor, a peripheral device controller, a memory array, an ASIC, and so forth.

Communication links 106 and 126 comprise the circuitry each device employs to send and receive information at high data rates across data channel 110. In one embodiment, links 106 and 126 have substantially similar or analogous designs. For purposes of simplicity, some features of the invention are described herein with reference to only one of the links 106 and 126. It will be appreciated, however, that each of the links may include the features or circuits of the other.

Referring now to FIG. 2, a block diagram illustrating selected elements of communication link 106 is shown. In the depicted embodiment, communication link 106 is a transceiver that includes a transmitter 130 and a receiver 150. Transmitter 130 includes a transmit interface 132 that converts received data to serial data suitable for transmission over channel 110. Data received by transmitter 130 is typically parallel, digital data having CMOS voltage levels. In such a case, transmit interface 132 converts the parallel data to serial data and typically converts the CMOS voltage levels to voltage levels and logic formatting suitable for transmission over transmission channel 110. In one embodiment of particularly widespread application in high speed serial links, transmit interface 132 generates serial data in a non-return to zero (NRZ) format desirable for its lower bandwidth requirements. In addition, the transmit-side clock signal is implicitly embedded with the data produced by transmit interface 132 to conserve the number of interconnects required.

Transmitter 130 as depicted further includes a pattern generator 134 that provides data to transmit interface 132. Pattern generator 134 is preferably enabled to generate a random data pattern as well as various selected other patterns designed to stress the susceptibility of various components of the communication system. During normal circuit operation, pattern generator 134 is disconnected from transmit interface 132. During at-speed testing, pattern generator 134 is connected and provides the inputs to transmit interface 132.

As depicted in FIG. 2, receiver 150 includes a receive interface 152, clock/data recovery (CDR) circuit 170, and a data select circuit 156. Receive interface 152 is responsible for recognizing the data format (e.g., NRZ) of the signal on transmission channel 110 and converting the signal to conventional (e.g., CMOS) voltage levels. CDR circuit 170 is typically a phase lock loop (PLL)-based circuit that recovers and segregates the clock and data signals, which typically appear as a single signal on transmission channel 110. Data select circuit 156 extracts the data from the output of CDR circuit 170 and readies or buffers the data for output to conventional digital logic circuits.

As depicted in FIG. 2, receiver 150 further includes a debug unit 160. Debug unit 160 is preferably integrated within receiver 150 on a single piece of semiconductor substrate. Debug unit 160 receives the recovered data from data select circuit 156 as well as information from the internals of CDR circuit 170. Debug unit 160 determines a BER from the recovered data. Debug unit 160 also uses the internal CDR signals to derive lower level indicators of the link's channel performance. Likely embodiments of CDR circuit 170 provide debug unit 160 with internal signals from which debug unit 160 can determine the link's low frequency and high frequency jitter statistics. Debug unit 160 then evaluates the link statistics and the BER to make a precise decision about the link/channel combination. By considering link statistics such as high frequency jitter in conjunction with a BER, debug unit 160 is able to provide a more accurate indication of potential problems with the design when the error rate is higher than permitted.

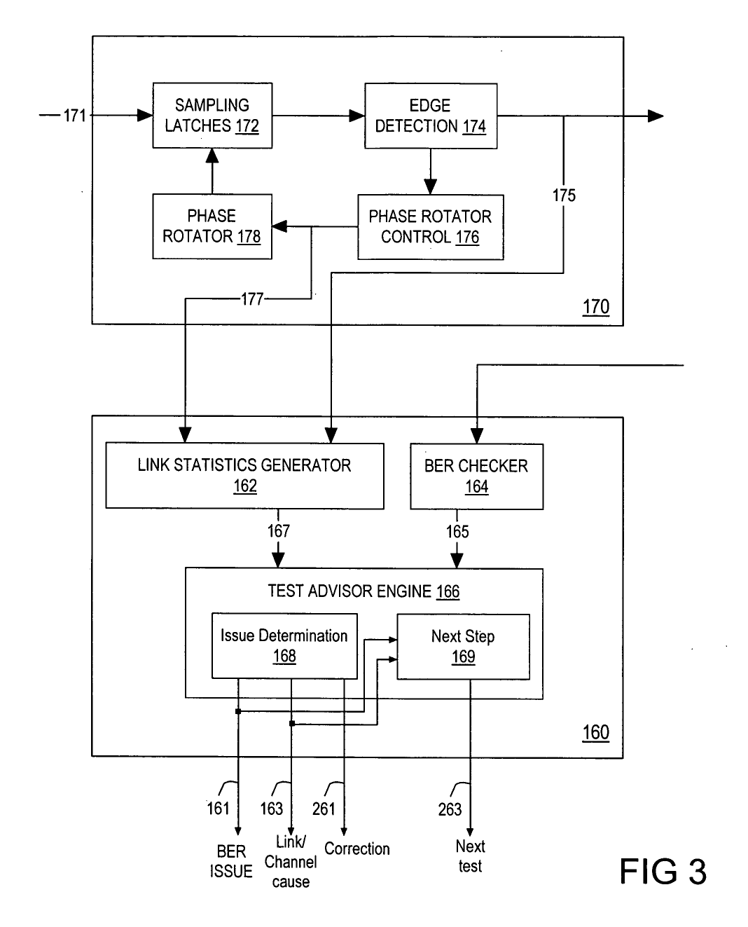

Referring now to FIG. 3, additional detail of CDR circuit 170 and debug unit 160 is illustrated. In the embodiment depicted in FIG. 3, CDR circuit 170 includes sampling latches 172 that receive and sample the incoming serial signal 171 from receive interface 152 (of FIG. 2). The sampled data is provided to an edge detector 174. Edge detector 174 (also referred to as a phase detector) determines the placement (in time) of signal transitions. Edge detector 174 produces an output 175 that is indicative of the short-term phase error of the incoming signal. If a signal transition occurs later than its expected transition, for example, edge detector 174 produces an output 175 that is indicative of the edge's actual placement relative to its expected placement. This output is also an indicator of how far the sampling clocks are from the center of the “eye” of the input serial data signal. The phase error output of edge detector 174 is received by a phase rotator controller 176. Phase rotator controller 176, in conjunction with phase rotator 178, monitors the phase error at edge detector 174 and attempts to compensate for at least a portion of the phase error by modifying the clocking of sampling latches 172.

In the depicted embodiment, a link statistics generator 162 of debug unit 160 receives information from the internals of CDR circuit 170. Specifically, link statistics generator 162 receives output 175 from edge detector 174 and output 177 from phase rotator control 176. Using these signals as its inputs, link statistics generator 162 is configured to measure characteristics of the link/channel system. In one embodiment, link statistics generator 162 generates statistics 167 including integrals (i.e., average values) and peak values of phase rotator movements and data edge movements. These statistics 167 are provided to a test advisor engine 166 of debug unit 160 and used to estimate characteristics of the link, including high frequency jitter and low frequency jitter, sometimes also referred to as frequency offset.

Specifically, low-frequency jitter, is generally deterministic jitter that can be isolated by implementing a filtering (integrating or averaging) finction on the output of phase rotator control 176. In such an implementation, phase rotator control unit 176 produces output 177, which is then used by link statistics generator 162 to generate a low-frequency jitter indicator. Similarly, edge detection unit 174 produces output 175, which can then be used by link statistics generator 162 to generate a high-frequency jitter indicator via a filtering function. Additionally, link statistics generator 162 may adjust the high-frequency indicator using the low-frequency indicator value when the application has very high frequency offset. The exact filtering functions and adjustments employed are implementation specific details.

Debug unit 160 as depicted in FIG. 3 includes a BER checker 164 that receives the recovered data via data select block 156 (see FIG. 2). BER checker 164 is configured to verify the data recovered by CDR 170 and to compare this data to the original data pattern to determine the rate at which errors occur. BER checker 164 provides a signal 165 to test advisor engine 166 that is indicative of the link's BER.

As depicted in FIG. 3, test advisor engine 166 receives statistical information 167 from link statistics generator 162 and BER information 165 from BER checker 164. Test advisor engine 166 is configured to evaluate the received information to generate a conclusion about the communication channel and/or link and to recommend additional testing or design modifications where appropriate. Test advisor engine 166 may be implemented as a micro-coded decision making algorithm for producing a particular test recommendation. In other embodiments desirable for their relative simplicity, test advisor engine 166 is implemented with a lookup table (LUT) structure.

In either embodiment, test advisor engine 166 is configured to generate a recommendation based on the combination of lower-level link statistical information in conjunction with an actual BER. In the embodiment depicted in FIG. 3, test advisor engine 166 includes an issue determination unit 168 and a next step unit 169. Issue determination unit 168 is configured to generate signal 161 indicating whether there is a BER issue (i.e., whether the BER exceeds a predetermined threshold) and a signal 163 indicating whether the link, the channel, or a combination of the two is responsible for the problem. Issue determination 168 may also generate an optional corrective action signal 261 that may be used to initiate automated corrective action when the BER is too high. Signals 161 and 163 are routed to next step unit 169, which uses the signals to determine which, if any, test should be performed next. In the depicted embodiment, next step unit 169 outputs a next step signal 263 from which the next test to be performed can be determined thereby facilitating an automated test flow procedure in which a sequence of tests is performed in sequence without user intervention until a potential cause of any unacceptable error rate is identified. Although issue determination unit 168 and next step unit 169 are illustrated as distinct units in FIG. 3, portions of each unit may be implemented within a look up table as described below.

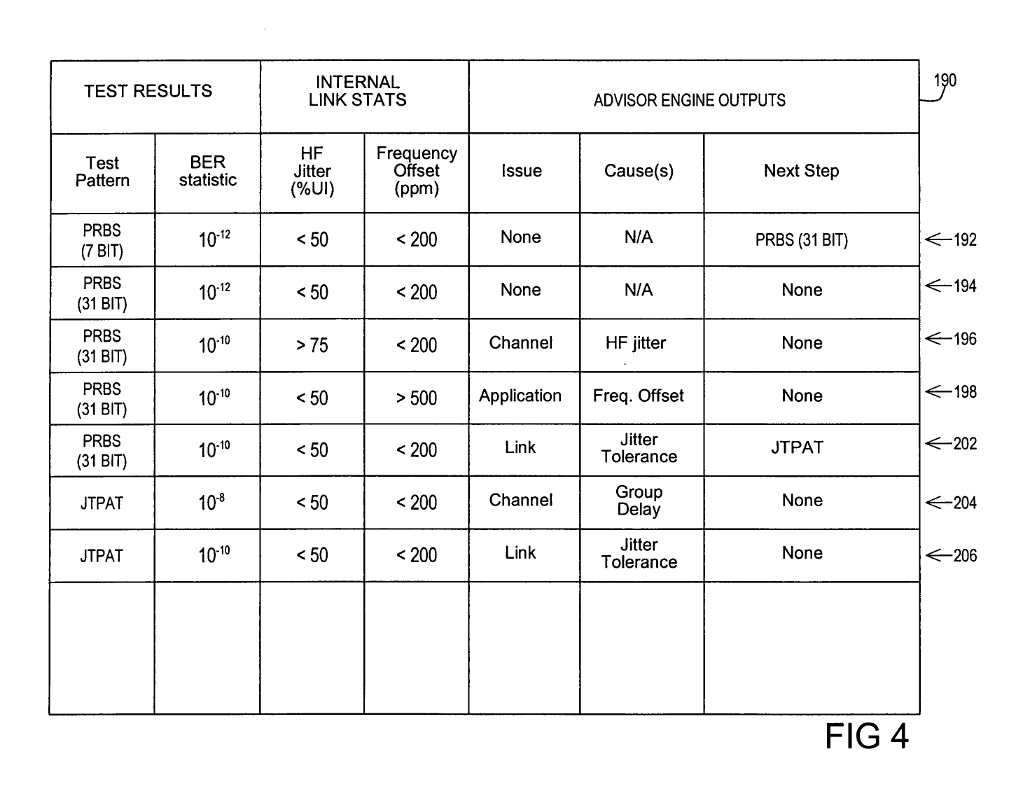

Referring to FIG. 4, an exemplary LUT 190 for implementing a decision making process performed by test advisor engine 166 is depicted. In the depicted embodiment, test advisor engine 166 generally evaluates the BER statistic to determine if the system is exhibiting unacceptable levels of errors and, if so, it considers the link statistics to determine a possible source of the errors and a possible correction. FIG. 4 is intended to illustrate various combinations of BER statistics and link statistics representing the scenarios most likely to be encountered and is not intended to be exhaustive of every LUT entry that may form a part of the process.

As illustrated in FIG. 4, the LUT 190 includes a set of entries ordered according to four variables (columns), namely, the test pattern used, the BER rate, a high frequency jitter margin statistic (expressed as a percentage of the unit interval (UI)), and a frequency offset statistic (expressed as in ppm). LUT 190 as shown produces at least three outputs including an Issue output, a Cause output, and a Next Step output, which correspond respectively to signals 161, 163, and 263 of FIG. 3. Test advisor engine 166 accesses entry (row) 192 of LUT 190, for example, when a particular test environment produces an acceptably low BER (10⁻¹² max), an acceptable jitter margin statistic (<50% UI), and an acceptable frequency offset statistic (<200 ppm) when stressed with a 7-bit PRBS. In this case, the conclusion is that the link/channel combination is functioning properly under the relatively relaxed conditions of the 7-bit pattern. The depicted embodiment of LUT 190 generates outputs indicating that there is no BER issue and recommends a 31-bit PRBS as a next test. In entry 194, the BER statistic and the high frequency jitter values are both acceptable when tested with the 31-bit PRBS. In this case, the test advisor engine outputs signals indicating that there is still no BER issue and that no additional testing is necessary. Test advisor engine 166 accesses entry 196 in LUT 190, when testing with a 31-bit PRBS produces an unacceptable BER (>10⁻¹²) and the link statistics indicate an unacceptable HF jitter, but an acceptable frequency offset. In this case, test advisor engine 166 is concludes that the channel is harder than expected and that the design of receiver 150 is less jitter tolerant than desired. In such a case, correction signal 261 may recommend a modification of the sampling and averaging scheme employed by CDR 170. In entry 198, high BER is accompanied by an acceptable jitter statistic, but an unacceptable frequency offset statistic (>500 ppm). In this case, table 190 concludes that CDR 170 is susceptible to phase offset and recommends an examination of the CDR's bandwidth. Entry 202 is accessed when a high BER is accompanied by acceptable link statistics using a 31-bit PRBS. Because the cause of the high BER is not revealed by the link statistics, test advisor 166 recommends, via next test signal 263, stressing the configuration with a jitter tolerance pattern. If the jitter tolerance pattern produces an even high BER, as in entry 204, then channel group delay is reported as the source of the problem. If the jitter tolerance pattern does not produce additional errors (entry 206), then the link is suspected and additional link diagnostics are recommended.

The organization of and arrangement of entries in table 190 as depicted in FIG. 4 may be leveraged to provide an automated sequence of testing the link/channel configuration, evaluating the generated data, accessing table 190 to retrieve a recommendation, and then performing the recommended action without additional user intervention. In the case where the recommendation is for additional testing, for example, the debug unit may be configured to initiate the additional testing automatically.

It will be apparent to those skilled in the art having the benefit of this disclosure that the present invention contemplates a mechanism for on-board testing of a communication link. It is understood that the form of the invention shown and described in the detailed description and the drawings are to be taken merely as presently preferred examples. It is intended that the following claims be interpreted broadly to embrace all the variations of the preferred embodiments disclosed.

1. A communication link for use in a data processing system, comprising:
a receive interface to receive and convert the voltage levels of a test signal transmitted over a communication channel, where the test signal carries a clock signal and a test data signal;
a clock/data recovery (CDR) circuit coupled to the receive interface and enabled to extract the clock signal and the test data signal from the received signal; and
a debug unit configured to determine a bit error rate (BER) of the test data signal and further configured to determine at least one jitter characteristic of the communication link, wherein the debug unit further includes a test advisor configured, based on the BER and the at least one jitter characteristic.

2. The communication link of claim 1, further comprising a transmitter including a transmit interface connected to the communication channel and a pattern generator, wherein the transmit interface is connectable to the pattern generator.

3. The communication link of claim 1, wherein the receive interface is configured to convert non-return to zero (NRZ) formatted serial data to parallel CMOS data.

4. The communication link of claim 1, further comprising recommending corrective action responsive to the BER exceeding a specified threshold, wherein the corrective action recommended by the debug unit includes performing at least one additional test when the BER exceeds the predetermined threshold and each of the at least one jitter characteristics is acceptable.

5. The communication link of claim 4, wherein the at least one additional test includes the use of a jitter tolerance pattern.

6. The communication link of claim 1, further comprising recommending corrective action responsive to the BER exceeding a specified threshold, wherein the corrective action recommended by the debug unit includes modifying a characteristic of the CDR when the BER exceeds the predetermined threshold and at least one of the jitter characteristics exceeds a specified threshold.

7. The communication link of claim 6, wherein said modifying of a characteristic comprises modifying a rate of sampling the transmitted signal by the CDR when the at least one jitter statistic that exceeds the predetermined threshold is a statistic indicative of the high frequency jitter of the communication link.

8. The communication link of claim 6, wherein said modifying of a characteristic comprises modifying a bandwidth of the CDR when the at least one jitter statistic that exceeds the predetermined threshold is a statistic indicative of the communication link's frequency offset.

9. The communication link of claim 1, wherein the CDR circuit includes an edge detector and a phase rotator control unit, wherein an output of the phase detector indicative of the link's high frequency jitter and further an output from the phase rotator control unit indicative of the link's frequency offset are provided to the debug unit.

10. The communication link of claim 1, wherein the debug unit employs and accesses a look up table (LUT) containing a plurality of entries, each entry having an associated BER value and at least one jitter characteristic value, to facilitate the corrective action recommendation.

11. A data processing system, comprising:
a first device connected to a communication channel, the first device including a communication link having a pattern generator and a transmit interface to convert a test pattern generated by the pattern generator to a test data signal for transmission via the communication channel;
a second device connected to the communication channel, the second device including a communication link receiver, comprising:
a receive interface to receive and convert the voltage levels of the test data signal transmitted over a communication channel, where the test data signal carries a clock signal and a test data signal;
a clock/data recovery (CDR) circuit coupled to the receive interface and enabled to extract the clock signal and the test data signal from the received signal; and
a debug unit configured to determine a bit error rate (BER) of the test data signal and further configured to determine at least one jitter characteristic of the link, wherein the debug unit further includes a test advisor configured to recommend, based on the BER and the at least one jitter characteristic, corrective action responsive to the BER exceeding a predetermined threshold.

12. The system of claim 11, wherein the corrective action recommended by the debug unit includes performing at least one additional test when the BER exceeds the predetermined threshold and each of the at least one jitter characteristics is acceptable.

13. The system of claim 11, wherein the corrective action recommended by the debug unit includes modifying a characteristic of the CDR when the BER exceeds the predetermined threshold and at least one of the jitter characteristics exceeds a specified threshold.

14. The system of claim 13, wherein said modifying of a characteristic comprises modifying a rate of sampling the transmitted signal by the CDR when the at least one jitter statistic that exceeds the predetermined threshold is a statistic indicative of the link's high frequency jitter.

15. The system of claim 13, wherein said modifying of a characteristic comprises modifying a bandwidth of the CDR when the at least one jitter statistic that exceeds the predetermined threshold is a statistic indicative of the link's frequency offset.

16. The system of claim 11, wherein the CDR circuit includes an edge detector and a phase rotator control unit, wherein an output of the phase detector indicative of the link's high frequency jitter and further an output from the phase rotator control unit indicative of the link's frequency offset are provided to the debug unit.

17. The system of claim 11, wherein the debug unit employs and accesses a look up table (LUT) containing a plurality of entries, each entry having an associated BER value and at least one jitter characteristic value, to facilitate the corrective action recommendation.

18. An integrated circuit, comprising:
a transceiver including a receive interface suitable for connecting the integrated circuit to a serial communication channel;
a clock/data recovery circuit (CDR) connected to the receive interface and configured to extract a clock signal and a test data signal from a signal received via the communication channel;
a debug unit including means for determining a bit error rate (BER) of the test data signal and means for determining at least one jitter characteristic of the communication link and further including means for using the BER and the at least one jitter characteristic to generate an action recommendation if the BER exceeds a specified threshold.

19. The integrated circuit of claim 18, wherein the debug unit includes means for determining high frequency jitter magnitude and frequency offset of the communication link.

20. The integrated circuit of claim 19, wherein the means for generating an action recommendation includes means for accessing a look up table (LUT) to retrieve the action recommendation based on the BER, the high frequency jitter margin, and the frequency offset.
